(19) United States
(12) Patent Application Publication
(10) Pub. No.: US 2006/0266460 A1
(43) Pub. Date: Nov. 30, 2006

(54) Method for fixing a functional element, particular a seal, to a glass pane of vehicle glazing

(76) Inventor: Bernhard Kreye, Wunstorf (DE)

Correspondence Address: WILLIAM COLLARD;COLLARD & ROE, P.C., 1077 NORTHERN BOULEVARD, ROSLYN, NY, 11576, US

(21) Appl. No.: 10/557,441

(22) PCT Filed: Mar. 27, 2004
(86) PCT No.: PCT/DE04/00642

§ 371 Date: Nov. 18, 2005

(30) Foreign Application Priority Data
May 20, 2003 (DE) 103-22-637.0

(51) Int. Cl. B32B 37/12; B32B 17/00; B32B 38/00; B60J 10/02

(52) U.S. Cl. 156/107; 156/280; 156/297

(57) ABSTRACT

In order to attach a functional element, particularly a seal, to a glass pane, particularly a glass pane of vehicle glazing, an adhesive is applied to a predetermined surface region of a clip. Every clip is set into a predetermined position on the surface of the pane provided for this purpose. After the adhesive has cured, the functional element is engaged with the clips with a positive lock, and afterwards, a connection region that is common to the clips, the functional element, and the glass pane has a sealing compound cast onto it, using the free casting method, and is at least partially covered when this is done.

### The invention relates to a method for attaching a functional element, particularly a seal, to a glass pane, particularly a glass pane of vehicle glazing.

In the case of vehicle glazing, the edges of glass panes are surrounded with functional elements, particularly seals, and the glass panes equipped with seals in this manner can then be inserted into the corresponding car body openings of the vehicles by the vehicle manufacturer.

It is known to injection-mold functional elements such as seals, holder frames, covers, or the like onto glass panes, i.e. to connect such elements with the panes by directly extruding them on. However, this method has the disadvantage that the absolute shape retention of the functional elements, e.g. of the seal profile with the corresponding sealing lips, cannot be guaranteed during its shaping by means of extrusion onto the pane. For this reason, the use of pre-finished seals or seal profiles is generally preferred. In order to be able to reliably and permanently connect such pre-finished functional elements with a glass pane, first of all it is necessary to bring the pane and the pre-finished functional element together. In this connection, the functional element must also be positioned on the glass pane in the orientation, location, and position intended for this purpose. The functional element must then be held in the predetermined position until it is permanently attached to the glass pane, for example due to binding or curing of connecting adhesive that was applied. Afterwards, the glass pane, prepared in this manner, can be passed on to further use. It is usual to use appropriate devices, gages, and similar assembly aids, for bringing together the parts to be connected with one another, the glass pane, on the one hand, and the seal as a functional element, on the other hand, positioning them, and holding them. Making appropriately configured, operationally reliable devices and/or assembly aids available requires not insignificant investments as well as subsequently incurred maintenance and repair costs.

The invention is based on the task of finding a method for attaching a functional element, particularly a seal, to a glass pane, preferably for vehicles, in which it is possible to do without the use of cost-intensive devices and/or assembly aids and similar aids for controlled holding and/or positioning of the parts to be connected with one another.

This task is accomplished, according to the invention, by means of a method having the characteristics of claim 1.

Advantageous further developments and embodiments of the sequence of measures to be carried out as indicated in claim 1 result from the dependent claims 2 to 11.

It is an essential principle of the invention to use a clip to be attached at a predetermined location of the glass pane as an intermediate holder, before positioning the functional element on the glass pane. The functional element can be attached, i.e. engaged to the clip by means of a suitable positive-lock connection, whereby the functional element sits in its predetermined position on the glass pane as soon as it has locked into the clip that is already seated on the glass pane. Subsequently, final securing of the connection between glass pane and functional element still takes place, in that regions on the outer surfaces of clip, functional element, and glass pane selected for this purpose have the sealing compound poured around them, in a free casting process, whereby the connection region common to clip, functional element, and glass pane is at least partly covered by the sealing compound.

Several clips can be disposed next to one another, in a row, on the glass pane. It is possible to assign a related clip to each functional element. Every clip can be produced as an injection-molded part made of plastic, for example of polypropylene, having a Shore hardness of 40, for example.

Every clip can consist of a foot that is plate-shaped, for example, from which a mushroom-shaped engagement element rises up. The surface of the plate-shaped foot of the clip that faces away from the engagement element can be coated with adhesive. Of course, any other embodiment of a clip is possible, as long as it is suitable for being used to carry out the method.

For this purpose, the functional element has a positive-lock element, for example a depression, a groove, or the like, which can engage with the clip, at a location provided therefor. With this depression or groove, it is possible to press the functional element onto the clip, i.e. onto its engagement element, so that functional element and clip are engaged with one another with a positive lock.

If the clip has previously been attached to the glass pane with adhesive, a type of preliminary connection between functional element and clip has been created by the clip, bringing about a predetermined positioning, i.e. fixation of the functional element on the glass pane, in each instance.

The final connection, i.e. securing of the connection of the functional element with the glass pane then takes place by means of the sealing compound that is applied to glass pane, parts of the clip, and parts of the functional element, using the free casting process.

Preferably, a curable polyurethane is used as the sealing compound. Single-component as well as two-component mixtures are suitable for the sealing compound.

By means of applying the sealing compound using the free casting process, projections, undercuts, surfaces and similar positive-lock elements that are located on the clips, the functional element, and the glass pane, specifically in the same connection region, are clamped to one another by means of curing of the sealing mass.

It is particularly advantageous if an extruded profile configured as a clip bar is used for the clips when implementing the method according to the invention. The clip bar is therefore a pre-finished endless part, produced using the extrusion process, for example, which is either cut to a desired length, in each instance, before being connected with the glass pane, or can also be shortened accordingly by means of a cutting step, in each instance, while being connected with the glass pane.

The clip bar, just like every individual clip, can, of course, also have a depression as a positive-lock element that serves for engagement with the functional element. For example, a clip bar having an approximately V-shaped or U-shaped cross-section is possible, in which one U shank forms the surface that can be coated with adhesive, and the other U shank acts more or less with elastic resilience. Such a U-shaped clip bar can be attached to the glass pane by means of gluing, for example, in such a manner that an engagement element that projects from a corresponding functional element can be pushed in from the side, while the U shank of the “U” that is essentially lying down is spread open with elastic resilience. At least one of the two U shanks can have a thickened part in the region of its free end, which projects relative to the other U shank, in each instance, by means of which the gap between the U shanks is reduced. In this way, the engagement effect is produced or improved.

Every clip or every clip bar can be glued to the surface of a glass pane, in each instance, using a suitable adhesive.

It is particularly advantageous to use a hot-melt glue as an adhesive when implementing the method according to the invention. Hot-melt glues have the advantage that they harden rapidly and offer the possibility of connecting the clip with the glass of the pane, for example without the prior application of a primer.

Hot-melt glues furthermore have the advantage that they can be reactivated at any time, even after they have already been applied, for example by applying heat. But other adhesives could also be redissolved after they have already dried, for example by applying a solvent, and thereby reactivated.

This possibility of reactivation of the adhesive is particularly advantageous when using clip bars, since these can be kept on hand or delivered as a pre-finished product, i.e. already provided with adhesive, for example in rod form or in roll form.

At the site of use, all that is then required is reactivation immediately before being set onto the glass pane.

Every clip or every clip bar can, as soon as it has been coated with adhesive, be brought to the glass pane and set onto it in a predetermined position, by means of a computer-controlled device. The computer-controlled device can be, for example, a usual industrial robot that has been appropriately programmed. Such an industrial robot can pick up every clip or every clip bar, individually, at the location where it is made available, bring it to an application station for adhesive, and subsequently bring it to glass panes that are located on a conveyor belt, for example, as well as set the clip or the clip bar on the glass pane in the predetermined position.

The functional element can also be brought in, positioned, and engaged with a positive lock with the clips or the clip bar that is/are located on the glass pane, by means of a similar computer-controlled device. Of course, however, it is also possible to set the functional element on and engage it manually.

It is also advantageous to use a computer-controlled device for applying the casting material to the connection region. For example, an industrial robot can pick up the glass pane that has been fitted with functional elements according to the invention, and bring it past a mouthpiece for sealing compound that is exiting from it, whereby the glass pane performs predetermined, computer-controlled movements relative to the mouthpiece. Likewise it is, of course, also possible, vice versa, to move the mouthpiece along the connection region to which the casting material is to be applied, under computer control.

A combination of controlled pane movement and mouthpiece guidance is also possible for application of the sealing compound.

After the sealing compound has cured, the functional element is securely connected with the glass pane, and by surrounding the clips or the clip bar, unintentional release of the clip connection, for example due to elastic resilience, is prevented to a great extent. After the sealing compound has cured, the clip is only minimally involved in the holding function between the functional element and the glass pane any longer. The cured sealing compound has taken over the significant portion of the holding function.

Exemplary embodiments of the invention, which show additional inventive characteristics, are shown in the drawing. This shows:

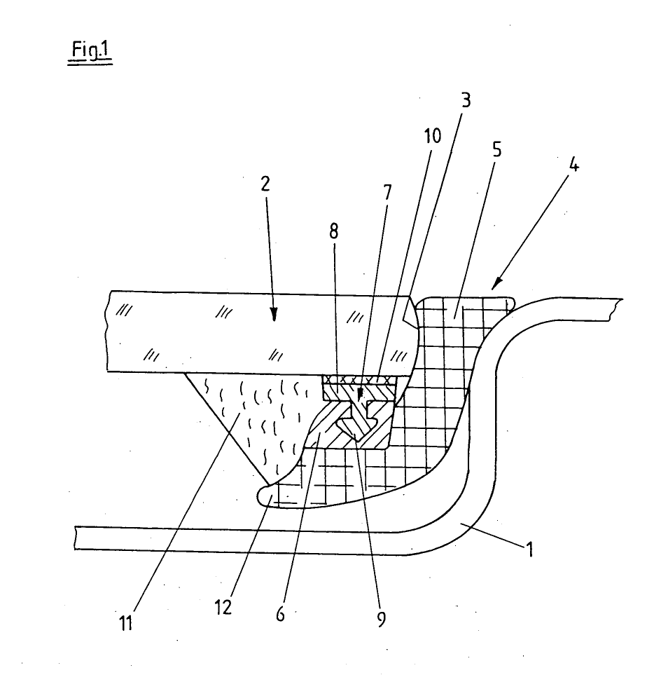

FIG. 1 a cross-sectional view of a roof frame of a vehicle body with an inserted glass pane, at the edge of which a functional element configured as a seal is attached in the manner according to the invention, and

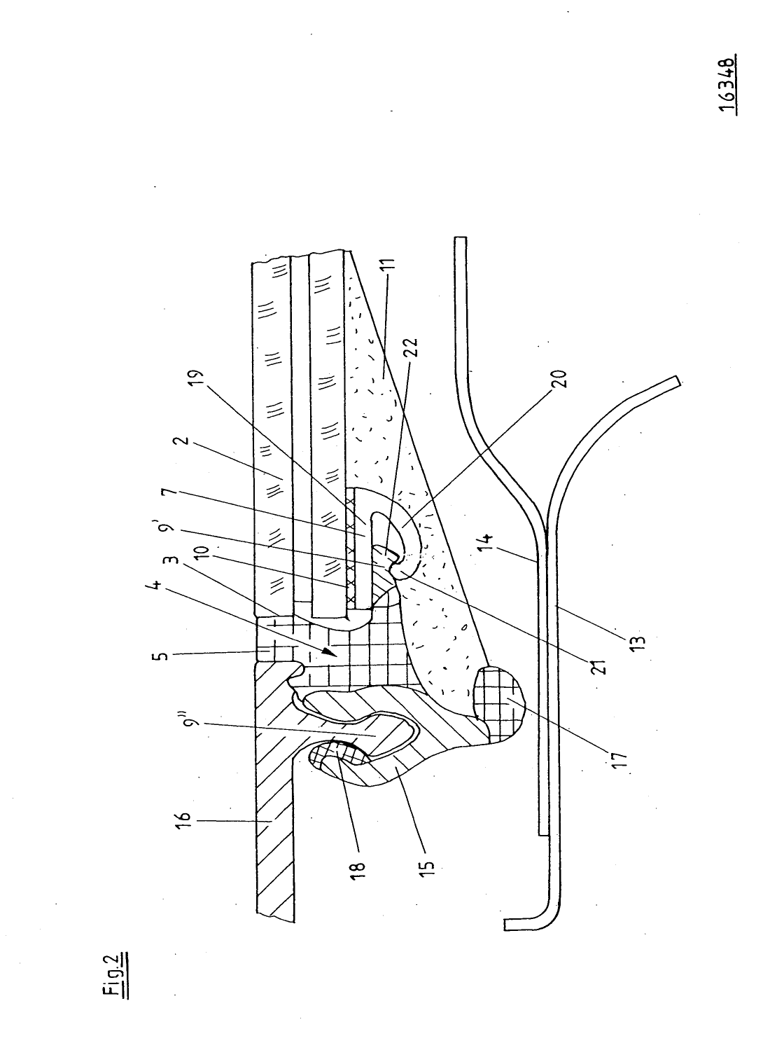

FIG. 2 a cross-sectional view of the attachment region of a windshield that has been set into a vehicle body, whereby a functional element is positioned and attached on the windshield by means of the method according to the invention, and whereby the clip or clip bar used has an approximately U-shaped cross-sectional shape.

FIG. 1 shows part of a roof frame 1 of a vehicle body, not shown in greater detail, in a cross-sectional view. A glass pane that is inserted into the roof frame 1 is referred to as 2. The gap between edge 3 of the glass pane 2 and the roof frame 1 is sealed with a functional element 4 that is configured as a seal 5.

The seal 5 consists of relatively soft, cellular plastic. The seal 5 is an endless profile that has been produced using the extrusion method. Using the so-called co-extrusion process, a predetermined region of the functional element 4, here the seal 5, is molded onto the functional element 4, the seal 5, as a so-called attachment segment 6. The attachment segment 6 consists of a hard plastic. An undercut groove is molded into the attachment segment 6, in its side that faces the glass pane 2.

The reference symbol 7 refers to a clip that consists of a foot plate 8, from which a projection 9 that is mushroom-shaped in cross-section rises. The foot plate 8 of the clip 7 is attached to the glass pane 2 in a predetermined position with adhesive 10, preferably a hot-melt glue. After the clip 7 has been attached, the functional element 4 can be connected with the clip 7 and thereby with the glass pane 2, in that the attachment segment 6 is pressed onto the projection 9 of the clip 7, whereby the projection 9 of the clip 7 engages with the attachment segment 6 with a positive lock.

As soon as the functional element 4 has been positioned on and attached to the glass pane 2 in the manner described above, the connection region that is common to the functional element 4, the clip 7, and the glass pane 2 is covered with a sealing compound 11 of polyurethane, using the free casting method. For this purpose, the glass pane 2 with the functional element 4 seated on it is held approximately vertically, in such a manner that the edge 3 with the functional element 4 located on it is in a relatively low position, at the bottom. In this connection, the projecting nose 12 of the functional element 4, which is molded on, the attachment segment 6, as well as the foot plate 8 of the clip 7, and, finally, the glass pane 2, form a groove into which the sealing compound 11 can be freely cast. After it has cured, the freely cast sealing compound 11 forms a wedge of sealing compound 11 that partially covers the glass pane 2, the clip 7, and the functional element 4, which wedge produces or secures the connection between glass pane 2 and functional element 4.

FIG. 2 shows a view of the attachment region of a windshield set into a vehicle body, in cross-section. Here again, only sheet metal parts 13 and 14 of the vehicle body can be seen. The windshield consists of the glass pane, again referred to as 2.

In this embodiment, the functional element 4, which again is present as a seal 5, has projections 9′ molded on by means of coextrusion, for engagement with a clip 7, as well as an accommodation 15 for engagement with a projection 9″ of a water tank cover 16 that sits next to the edge 3 of the glass pane 2.

The functional element 4, the seal 5, furthermore has additional sealing segments 17 and 18 in this exemplary embodiment. The functional element 4 therefore comprises the seal 5 with the sealing segments 17 and 18 of soft, preferably cellular plastic, as well as the projection 9′ and the attachment segment 6 of hard plastic.

The parts of hard and soft plastic can easily be shaped as an extruded profile, using the coextrusion method, in the production of the functional element 4.

In this exemplary embodiment, a clip 7 is connected with the glass pane 2, which clip has an approximately U-shaped cross-sectional shape. The clip 7 according to FIG. 2 has a U shank 19 that corresponds to the foot plate 8 of the clip 7 according to FIG. 1, as well as a second U shank 20, which has a head-like thickened part 21 at its free end.

In order to connect the U-shaped clip 7 with the glass pane 2, the U shank 19 is coated with adhesive 10, preferably a hot-melt glue, and set onto the glass pane 2. Once the clip is seated in its predetermined position on the glass pane 2, the functional element 4, which again must be connected with the clip 7, will also assume its predetermined position on the glass pane 2.

In order to connect the functional element 4 with the clip 7 that is seated on the glass pane 2, the functional element 4 is pushed from the side, from the left, between the U shanks 19 and 20, whereby the U shank 20 can be spread open with elastic resilience, until the nose 12 has engaged with the engagement projection 22 of the projection 9′.

As soon as the functional element 4 is seated on the glass pane 2 in its predetermined position, using the clip 7, free casting with the sealing compound 11 again takes place.

Free casting is easily possible if the glass pane is held in such a manner, while this is being done, that the clip 7, which holds the functional element 4 and is attached with adhesive 10, is located on its top. The glass pane 2 would assume this position if the drawing with FIG. 2 is rotated by 180°.

Once the sealing compound 11 has cured, it has surrounded the clip 7 as well as the projections 9, 9′, 9″ of the functional element 4. In particular, the U shank 20 can hardly spring open at all, so that it is only barely possible for the engagement of the projection 9′ to come loose from the clip 7.

The sealing compound 11 furthermore also connects functional element 4 and clip 7 with the glass pane 2, so that a relatively secure and rigid connection has been formed, which is furthermore also advantageous for a secure hold of the water tank cover 16 in the case of a windshield.

1. Method for attaching a functional element, particularly a seal, to a glass pane, particularly a glass pane of vehicle glazing, wherein an adhesive (10) is applied to a predetermined surface area of a clip (7), that every clip (7) is set onto the surface of the pane (2) intended for that purpose, in a predetermined position, that after the adhesive (10) has cured, the functional element (4) is engaged with the clips (7) with a positive lock, and that afterwards, a connection region that is common to the clips (7), the functional element (4), and the glass pane (2) has a sealing compound (11) cast onto it, using the free casting method, and is at least partially covered when this is done.

2. Method according to claim 1, wherein every clip (7) is set onto the pane (2) before the adhesive (10) that was applied has cured.

3. Method according to claim 1, wherein the applied adhesive (10) is reactivated before the clip (7) is set onto the pane (2).

4. Method according to claim 2, wherein a curable polyurethane is used as the sealing compound (11).

5. Method according to claim 4, wherein projections (9, 9′, 9″), undercuts, surfaces, and similar positive-lock elements that are located on the clips (7), the functional element (4), and the glass pane (2), in the common connection region, are clamped together by means of curing of the sealing compound (11).

6. Method according to claim 5, wherein an extruded profile configured as a clip bar is used for the clips (7).

7. Method according to claim 1, wherein a hot-melt glue is used as the adhesive (10).

8. Method according to claim 1, wherein every clip (7) coated with adhesive (10) is brought to the glass pane (2) and set into a predetermined position there, by means of a computer-controlled device.

9. Method according to claim 1, wherein the functional element (4) is brought up, positioned, and engaged with the clips (7) with a positive lock, using a computer-controlled device.

10. Method according to claim 1, wherein a computer-controlled device is used for casting the connection region.

11. Method according to claim 10, wherein a mouthpiece for sealing compound (11) exiting from it is guided along the connection region to be cast by means of the computer-controlled device.

12. Method according to claim 10, wherein the pane is held with a computer-controlled device, and moved in such a manner that the connection region to be cast is guided past a fixed mouthpiece for sealing compound (11).

13. Method according to claim 10, wherein a mouthpiece for sealing compound (11) exiting from it is guided along the connection region to be cast, and that the pane (2) is simultaneously held with a computer-controlled device, and moved in such a manner that the connection region to be cast is guided past the mouthpiece.
